(19) United States
(12) Patent Application Publication
(10) Pub. No.: US 2009/0217561 A1
(43) Pub. Date: Sep. 3, 2009

(54) Pivotal, Removable Holder for Interchangeable Window Signage

(76) Inventor: David C. Thompson, St. Charles, IL (US)

Correspondence Address: NIXON & VANDERHYE, PC, 901 NORTH GLEBE ROAD, 11TH FLOOR, ARLINGTON, VA, 22203, US

(21) Appl. No.: 12/324,332

(22) Filed: Nov. 26, 2008

Related U.S. Application Data
(60) Provisional application No. 60/991,453, filed on Nov. 30, 2007.

(51) Int. Cl. G09F 15/02

(52) U.S. Cl. 40/606.12; 40/606.01; 40/611.06; 40/606.19

(57) ABSTRACT

An example embodiment of a sign holder comprises a display support member configured to carry a sign without adherence of the sign to the display support member; an attachment member which is connected to the display support member so that the attachment member can be oriented relative to the display support display member at a selected one of a range of maintainable pivot angles; and means for securing the attachment member to an external surface.

### BACKGROUND

This application claims the priority and benefit of U.S. Provisional Patent Application 60/991,453, filed Nov. 30, 2008, which is incorporated herein by reference in its entirety.

I. Technical Field

This invention pertains to a holder for window signage, and particular to a temporary or removable window signage holder.

II. Related Art and Other Considerations

Many different types of decals or stickers are adhered to window surfaces, such as interior window surfaces of motor vehicles. For example, window decals enable students or alumni of a school to express support for their institutions. Other types of decals or stickers are adhered to other parts of a motor vehicle, such as to an auto bumper. Bumper stickers are popular ways of advertising products or ideas or simply making a statement (e.g., a political statement or a sociological statement expressed by a campaign bumper sticker).

The ease of application of an adhesive decal to an interior window of a motor vehicle varies with the contour and degree of inclination of the vehicle interior window. For example, adhesive decals are more difficult to apply and read for vehicles having a steep angled interior window surface.

The removal of an adhesive decal or sticker can be arduous and tedious. Often a sharp instrument must be employed to scrape the decal, or pieces of the decal, from the interior window surface or from a bumper. Even after a decal is removed, a gummy coating often remains on the surface where the decal or sticker previously resided.

Window display devices or automobile-related accessories having suction cups are illustrated in the following (all of which are incorporated herein by reference): US Design Patent 304,737 to Mori; U.S. Pat. No. 1,468,197 to Downing; U.S. Pat. No. 1,885,103 to Barnett; U.S. Pat. No. 4,953,315 to Romaine; and French Patent 2650104.

### BRIEF SUMMARY

In its various aspects the technology disclosed herein concerns embodiments of sign holders. In an example embodiment, a sign holder comprises a display support member configured to carry a sign without adherence of the sign to the display support member; an attachment member which is connected to the display support member so that the attachment member can be oriented relative to the display support display member at a selected one of a range of maintainable pivot angles; and means for securing the attachment member to an external surface.

In an example embodiment, a sign holder comprises a display support member; an attachment member; and means for securing the attachment member to an external surface. The a display support member comprises a panel section comprising a panel display surface; a lower clip connected proximate a lower end of the panel section and which is configured at least partially to form a lower channel; an upper clip connected proximate an upper end of the panel section and is configured at least partially to form an upper channel. The lower clip and the upper clip at least partially form a track, the track being configured to receive or accommodate a sign which can be slidably inserted into or removed from the track, e.g., inserted or removed by sliding.

In an example implementation of the foregoing embodiment, the display support display member comprises a panel section comprising a panel display surface and a panel edge which is configured to form a pivot channel; and the attachment member comprises an attachment member edge which is configured for pivotal insertion into the pivot channel.

In another example embodiment a sign holder comprises a display support member configured to carry a sign; an attachment member configured to carry a second sign and connected to the display support member; and means for securing the attachment member to an external surface. In this example embodiment, the attachment member comprises an auxiliary panel; an auxiliary panel lower clip connected proximate a lower end of the auxiliary panel and which is configured at least partially to form an auxiliary panel lower channel; an auxiliary panel upper clip connected proximate an upper end of the auxiliary panel and which is configured at least partially to form an auxiliary panel upper channel. The auxiliary panel lower clip and the auxiliary panel upper clip at least partially form an auxiliary panel track, the auxiliary panel track being configured to receive or accommodate the second sign which can be slidably inserted into or removed from the auxiliary panel track (e.g., inserted or removed by sliding).

In another example embodiment, a sign holder comprises a display support member; an attachment member configured to carry a second sign and connected to the display support member; and means for securing the attachment member to an external surface. The display support member comprises: a panel section comprising a panel display surface; a lower clip connected proximate a lower end of the panel section and which is configured at least partially to form a lower channel; an upper clip connected proximate an upper end of the panel section and is configured at least partially to form an upper channel. The lower clip and the upper clip at least partially form a track, the track being configured to receive or accommodate a sign which can be slidably inserted into or removed from the track. The attachment member is configured to carry a second sign and connected to the display support member. The attachment member comprises an auxiliary panel. The auxiliary panel bears or carries a second sign. In one example implementation, the auxiliary panel has content of a second sign printed or embossed or otherwise affixed thereto. In another example implementation, the attachment member comprises, in addition to the auxiliary panel, an auxiliary panel lower clip connected proximate a lower end of the auxiliary panel and which is configured at least partially to form an auxiliary panel lower channel; an auxiliary panel upper clip connected proximate an upper end of the auxiliary panel and which is configured at least partially to form an auxiliary panel upper channel. The auxiliary panel lower clip and the auxiliary panel upper clip at least partially form an auxiliary panel track, the auxiliary panel track being configured to receive or accommodate the second sign which can be slidably inserted into or removed from the auxiliary panel track. In an example implementation, the means for securing the attachment member to the external surface comprises a pair of spaced apart suction cups positioned to preclude lateral translation of the second sticker along the auxiliary panel.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention. Any dimensions provided in the drawings are for an non-limiting example embodiment; in other embodiments the dimensions can differ.

FIG. 1 is an isometric view of a sign holder according to an example embodiment which bears a single sign.

FIG. 2 is a front view of the sign holder of the example embodiment of FIG. 1.

FIG. 3 is a left side view of the sign holder of the example embodiment of FIG. 1 in an essentially flat orientation.

FIG. 4 is a left side view of the sign holder of the example embodiment of FIG. 1 in a pivoted orientation.

FIG. 5 is a first enlarged left side view of an upper end of a display support display member of the example embodiment of FIG. 1.

FIG. 6 is a second enlarged left side view of an upper end of a display support display member of the example embodiment of FIG. 1.

FIG. 7 is an enlarged partial view of a display support display member of the example embodiment of FIG. 1.

FIG. 8 is an enlarged left side view of window attachment member 24 of the example embodiment of FIG. 1.

FIG. 9 is an isometric view of the sign holder according to FIG. 1 but bearing both a primary sign and an auxiliary sign.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

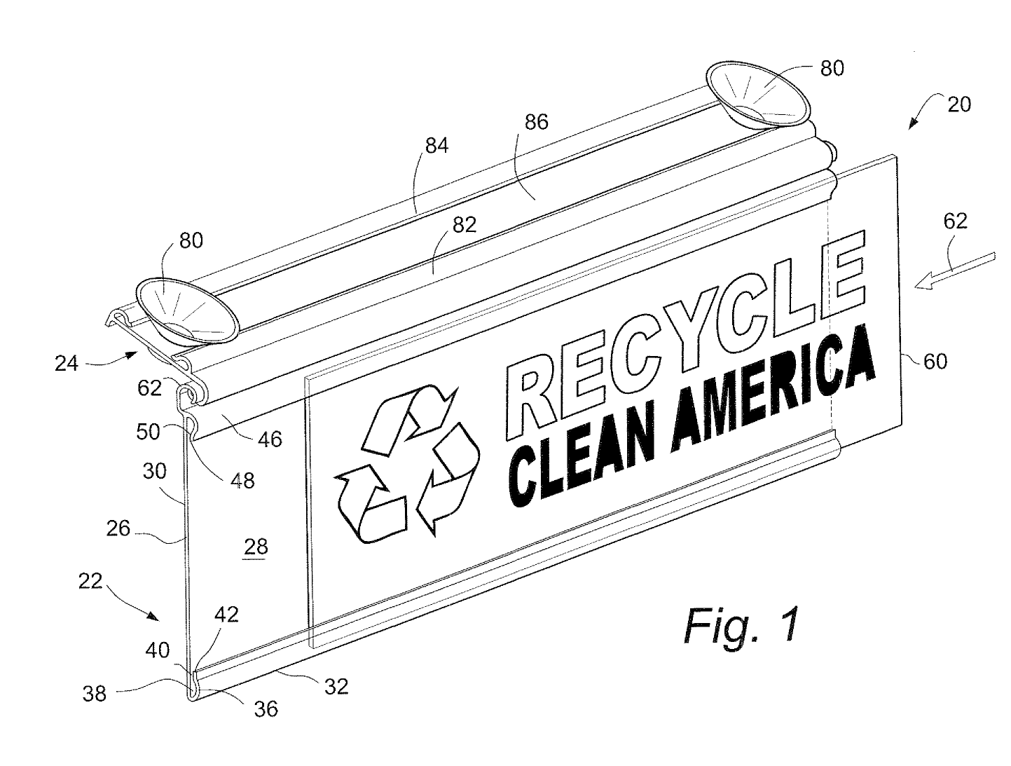

FIG. 1 shows a sign holder 20 according to an example embodiment. The sign holder 20 includes two members that pivot or rotate with respect to one another: display support member 22 and attachment member 24. At least one, and preferably both of display support display member 22 and attachment member 24 are preferably, but not necessarily, comprised of (e.g., formed from) a transparent material, such as a transparent hard plastic, for example.

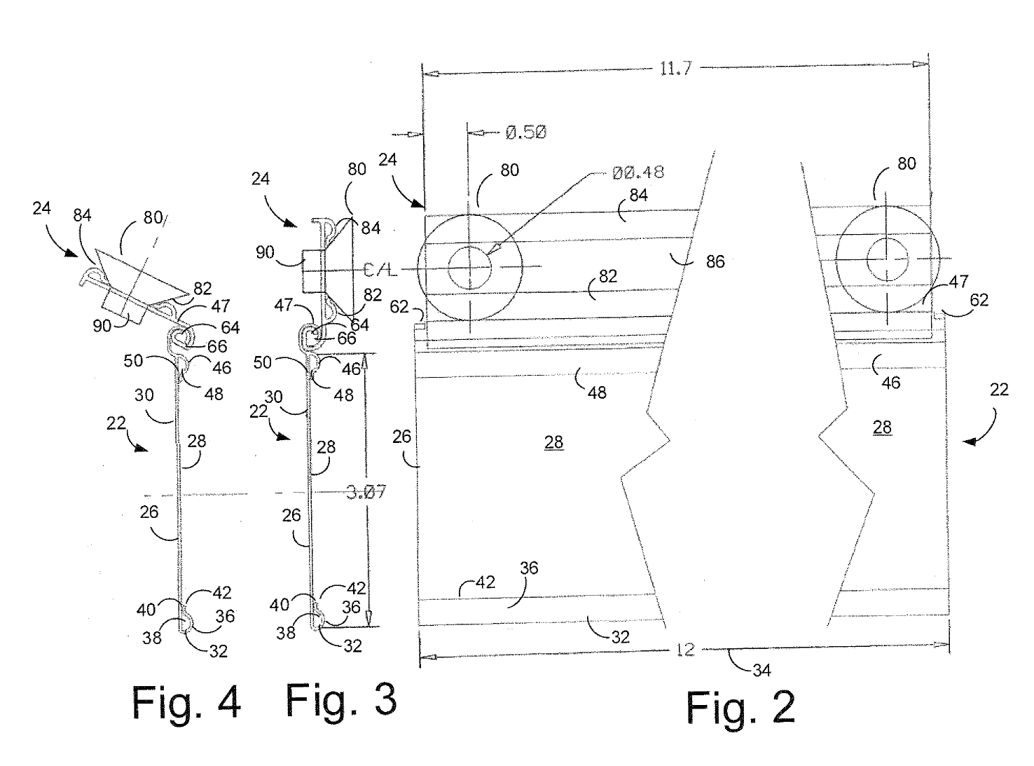

As also shown in FIG. 2 and FIG. 3, display support display member 22 comprises panel section 26 having a substantially flat, rectangular shape. The panel section 26 has panel front or panel display surface 28 and panel rear surface 30. Panel section 26 has panel lower edge 32 extending parallel to first axis 34. A curved lower clip 36 is formed to extend substantially along the entire length of panel lower edge 32. The lower clip 36 curves or otherwise turns back upon panel display surface 28 to form lower clip channel 38. A narrow lower slit 40, or a resilient lower nip, is provided between distal end 42 of curved lower clip 36 and panel display surface 28. In one example embodiment, the example display support display member 22 extends approximately twelve inches along first axis 34. For the particular example embodiment illustrated, measurements shown in the figures are in inches. It should be understood, however, that other dimensions and measurements are possible in other embodiments, and that no measurements provided or shown are critical unless otherwise noted or clear from the context of the description.

The panel section 26 also has curved upper clip 46 extending proximate an upper edge 47 thereof. Upper clip 46 curves symmetrically with curved lower clip 36 back toward panel display surface 28, and similarly has distal end 48. Narrow upper slit 50, or a resilient upper nip, is provided between distal end 48 of curved upper clip 46 and panel display surface 28. Collectively, the panel display surface 28, the curved lower clip 36, and curved upper clip 46 form a track into which a sign can be slidably inserted or removed (e.g., inserted or removed by sliding). In other words, the lower clip 36 and the upper clip 46 (together with panel display surface 28) at least partially form a track which is configured to receive or accommodate a sign which can be slidably inserted into or removed from the track.

While the example illustrated embodiment shows curved lower clip 36 and curved upper clip 46 as being means for retaining the sign on panel display surface 28, in other embodiments other types of sign retaining mechanisms and sign retaining mechanisms of other configurations can be provided. Alternatively, an adhesive-backed sticker, placard, or the like can be secured to panel section 26 by activation (e.g., exposure) of the sticker's adhesive backing.

As shown in FIG. 1, a sign 60 such as an essentially planar sticker, decal, or other flat display can have leading edges inserted into narrow lower slit 40 and narrow upper slit 50 so that the sign 60 can be slid into a direction 62 (e.g., parallel to first axis 34) and generally in contact with panel display surface 28 into the track which is at least partially formed by the lower clip 36 and the upper clip 46. Sliding or placement of the sign 60 is such that an upper elongated edge of sign 60 is secured beneath curved upper clip 46 and a lower elongated edge of sign 60 is secured beneath curved lower clip 36. Preferably the sign 60 extends along a length along first axis 34 which is essentially the same or shorter than panel section 26. Sliding insertion and sliding removal of sign 60 in this manner permits a sign to be selectively utilized in sign holder 20. When it is desired for another sign to be displayed, a sign which is currently displayed and be slid out of display support display member 22 and another sign, of either similar or dissimilar subject matter, and be inserted in its stead.

Thus, FIG. 1 illustrates an example, non-limiting embodiment of structure of a display support member which is configured to carry a sign without adherence of the sign to the display support member, e.g., with the use of an adhesive or the like. Preferably the sign is held in place by a mechanical clamping or engagement that can be selectively applied or released so that the sign can be selectively inserted and removed relative to the display support display member 22 without necessitating a bonding interaction of a surface of the sign with a surface of the display support display member 22.

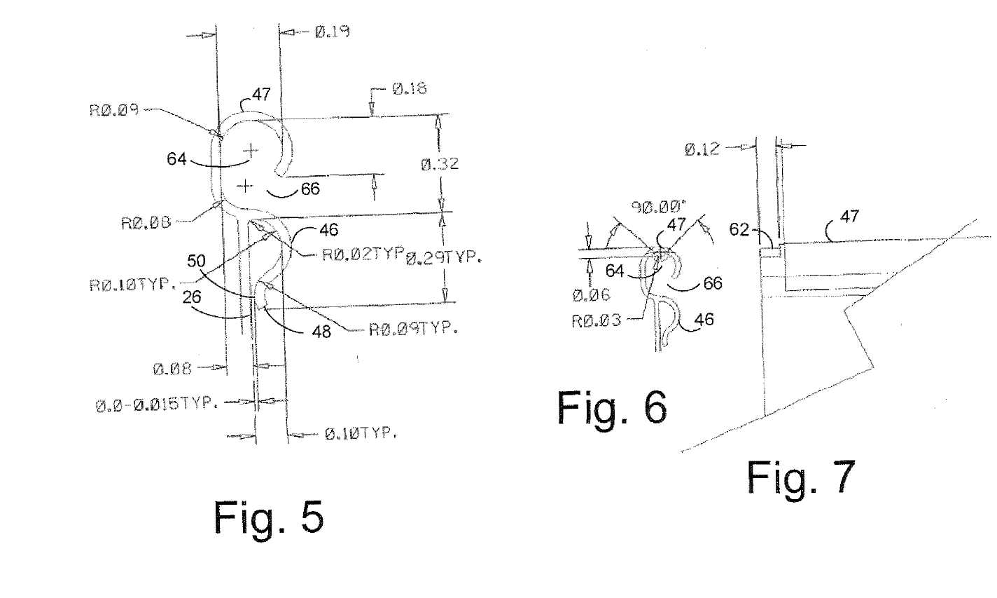

As shown in FIG. 2 and in more detail in FIG. 7, panel upper edge 47 has a recess or upset (e.g., indent 62) provided at its intersection with both transverse edges (the transverse edges are those which are essentially orthogonal to first axis 34, and thus to panel lower edge 32). Further, as shown in FIG. 2, FIG. 3, FIG. 4, and in more detail in FIG. 5 and FIG. 6, panel upper edge 47 is curved to form hinge channel or pivot channel 64. The curved panel upper edge 47 extends slightly rearward of panel rear surface 30 and then arcs forward in hook-like fashion to form pivot channel 64. A gap 66 extends between panel upper edge 47 and curved upper clip 46 and provides entrance to pivot channel 64.

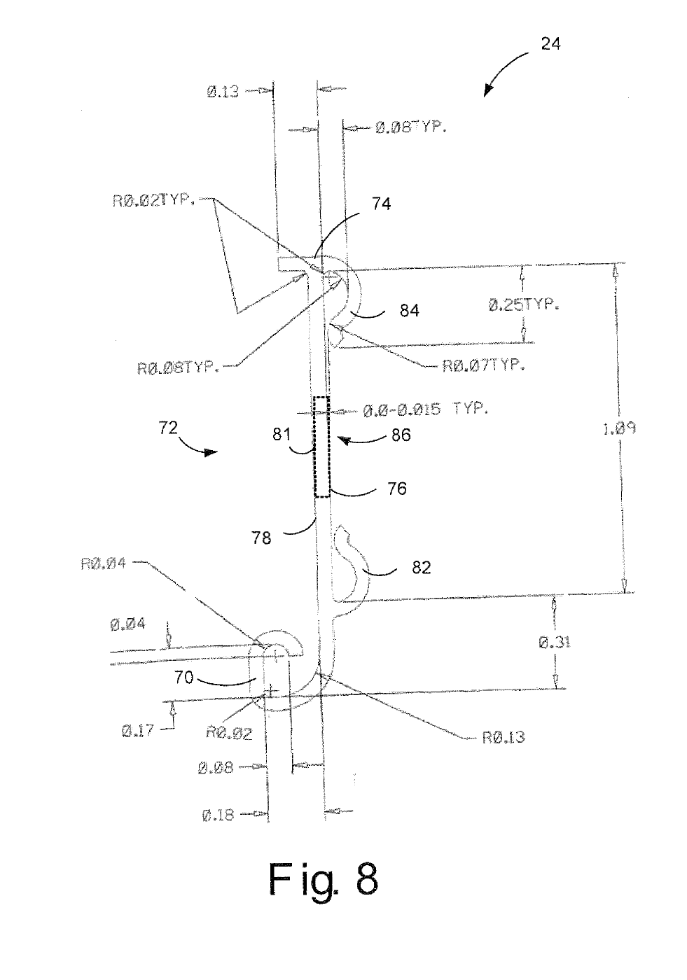

FIG. 8 shows window attachment member 24 in more detail. Attachment member 24 has lower or hinge edge 70; auxiliary panel 72; and upper edge 74. Auxiliary panel 72, essentially flat in the illustrated example embodiment, is intermediate hinge edge 70 and upper edge 74. Auxiliary panel 72 has both auxiliary panel front surface 76 and auxiliary panel rear surface 78.

Hinge edge 70 of attachment member 24 is curved to travel around in the direction of auxiliary panel rear surface 78 and back on itself in an essentially “C” shape. Hinge edge 70 is sized and configured for friction fit insertion into pivot channel 64 in the manner shown in FIG. 3 and FIG. 4, with the friction fit not being so great that attachment member 24 and display support display member 22 cannot pivot with respect to one another. An exterior surface of hinge edge 70 is thus sized and configured for contact with an interior surface of the portion of panel upper edge 47 that forms pivot channel 64, and to turn or pivot within pivot channel 64. The indent 62 also serves to precluding sliding or translation of display support display member 22 and attachment member 24 relative to one another along the first axis.

Concerning the pivoting capabilities of display support display member 22 and attachment member 24, FIG. 3 shows sign holder 20 of the example embodiment of FIG. 1 in an essentially flat orientation (e.g., with attachment member 24 oriented substantially planar to display support display member 22). FIG. 4, on the other hand, shows sign holder 20 in a pivoted orientation suitable, for example, for attachment to an inclined interior surface of a window such as an automobile window.

The pivotal connection of the attachment member 24 relative to the display support display member 22 is such that the two members can be pivoted through a range of angles relative to one another, so that a desired orientation of the display support display member 22 can be achieved and maintained relative to an external surface (e.g., an automobile window interior) to which the attachment member 24 is secured. That is, the pivotal connection is such that, once pivoted, a desired angular relationship between attachment member 24 and display support display member 22 can be maintained without significant further slippage. Thus, the pivotal connection of the attachment member 24 relative to the display support display member 22 is configured to provide a range of maintainable angular positions. In other words, the attachment member 24 can be oriented relative to the display support display member 22 at a selected one of a range of maintainable pivot angles. In an example implementation, the range of maintainable pivot angles is achieved through the friction fit of hinge edge 70 and pivot channel 64 in the manner essentially described above.

Auxiliary panel 72 carries two suction cups 80. Although shown in various other figures, suction cups 80 are not shown in FIG. 8. Rather, FIG. 8 shows cup holes 81 or apertures formed or provided in auxiliary panel 72 and through which base or butt ends of suction cups 80 can be inserted. Preferably the cup holes 81 are spaced apart, so that each suction cup 80 is proximate (e.g., slightly spaced away from) a transverse edge of attachment member 24.

The auxiliary panel 72 also serves as an auxiliary or alternative display member, thus providing a second display member in addition to primary display member 22. The auxiliary panel 72 bears or carries a second sign. In one example implementation, the auxiliary panel has content of a second sign printed or embossed or otherwise affixed thereto. In another example implementation, auxiliary panel 72 comprises lower auxiliary clip 82 and upper auxiliary clip 84. The auxiliary panel lower clip 82 and auxiliary panel upper clip 84 have analogous structure to curved lower clip 36 and curved upper clip 46 of display support display member 22, respectively. An auxiliary display region 86 extends between auxiliary panel lower clip 82 and auxiliary panel upper clip 84 in the direction of first axis 34.

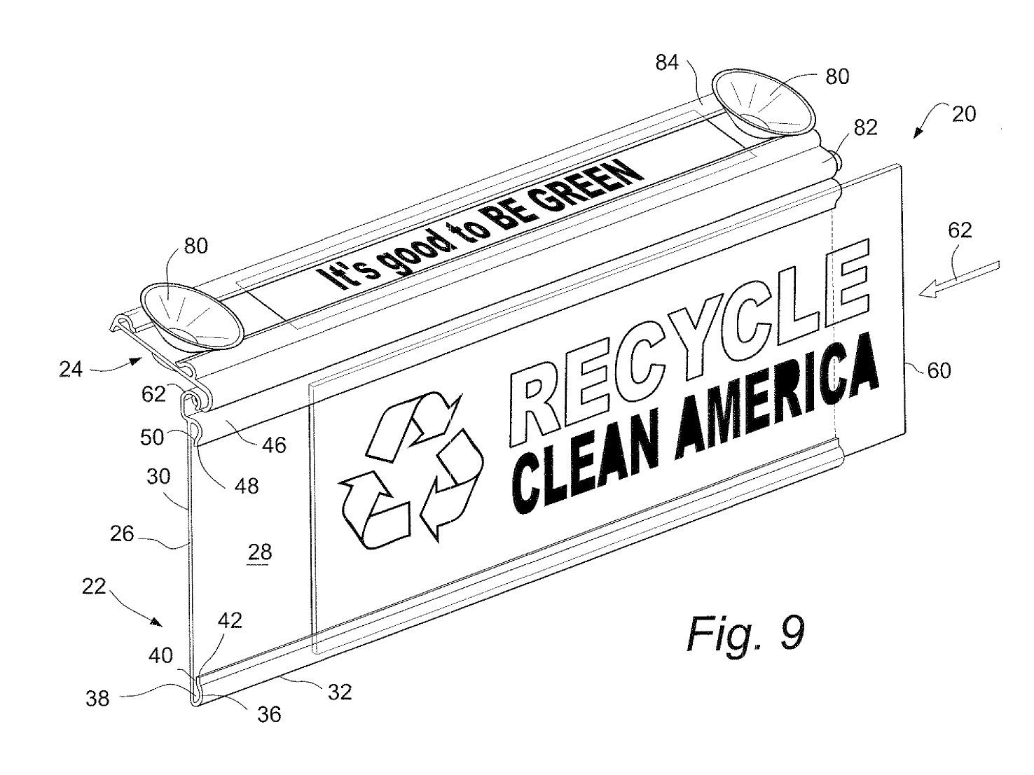

As shown in FIG. 9, a sticker, placard, or other indicator (referred to generically as “second sign” 88) can be inserted into a comparably formed track to have its backside lie on auxiliary display region 86 and its topside edges engaged or slid under lower auxiliary clip 82 and upper auxiliary clip 84. Alternatively, if the second sign 88 is adhesive-backed, the adhesive can be activated and the second sign 88 placed so that the second sign 88 is secured to the front face of auxiliary panel 72.

Thus, attachment member 24 comprises auxiliary panel lower clip 82 connected proximate a lower end of the auxiliary panel 72 and which is configured at least partially to form an auxiliary panel lower channel, as well as auxiliary panel upper clip 84 connected proximate an upper end of the auxiliary panel 72 and which is configured at least partially to form an auxiliary panel upper channel. The auxiliary panel lower clip 82 and the auxiliary panel upper clip 84 at least partially form an auxiliary panel track, the auxiliary panel track being configured to receive or accommodate the second sign 88 which can be slidably inserted into or removed from the auxiliary panel track.

FIG. 9 shows that sign holder 20 can bear both a primary sign 60 and an auxiliary or second sign 88. The primary sign 60 and auxiliary or second sign 88 may be of related, or entirely different, subject matter.

As stated previously, suction cups 80 each have cup base 90 which is insertable into respective cup holes 81 for anchoring suction cups 80 into auxiliary panel 72 of attachment member 24. When auxiliary panel 72 serves as an auxiliary display panel, the bases 90 of one or both of the cups 80 can be squeezed or otherwise deformed so that the cup 80 can be removed from cup holes 81. Removal of the cup(s) 80 allows for slidable insertion of the second sign 88 onto auxiliary display region 86 and (if desired) beneath the clip edges of lower auxiliary clip 82 and upper auxiliary clip 84. After slidable insertion of the second sign 88, the bases 90 of cup(s) 80 can be pressed back into cup holes 81. The cups 80 are then ready for securing the entire assembly to a window surface. Moreover, when pressed back into cup holes 81, the cups 80 (e.g., the annular lips of suction cups 80) protrude beyond a plane of the auxiliary panel 72 and thus also serve for precluding lateral translation or shifting of second sign 88 along the first axis 34.

Thus, as understood from the foregoing and accompanying figures, in an example embodiment sign holder 20 comprises display support display member 22 and attachment member 24 which are pivotally hinged to one another for adjustable angular positioning of a sign borne by panel section 26. The display support display member 22 facilitates selective display of different signs by virtue of allowing a sign 60 to be easily slid into and subsequently removed from a track formed by a panel display surface 28 as secured therein by curved lower clip 36 and curved upper clip 46. The sign holder 20 can be secured to a window surface such as an interior surface of an automobile window using suction cups 80 carried by the attachment member 24. As an optional variation, the attachment member 24 can be configured to have an auxiliary panel 72 which provides a auxiliary display region 86 for an additional or alternative indicator.

The display support display member 22 and attachment member 24 are hinged for pivotal movement by virtue of an upper edge of display support display member 22 being configured to form pivot channel 64. An essentially “C” shaped hinge edge 70 of the attachment member 24 fits into and travels along an interior wall of the pivot channel 64 to facilitate pivoting of display support display member 22 and attachment member 24 relative to one another, and thus adjustment of a display angle for the sign 60 carried by display support display member 22.

Various non-exhaustive embodiments illustrated herein show a hinged arrangement for effecting pivotal movement between the display support member 22 and attachment member 24. Yet in other embodiments the pivotal action between display support member 22 and attachment member 24 can be achieved by other structures.

In the non-exhaustive embodiments thus far described, suction cups 80 have been illustrated as the particular means employed for securing the attachment member 24 to an external surface such as an interior surface of a glass window (e.g., an automobile window). In other embodiments, the means for securing the attachment member 24 to an external surface can take other forms.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A sign holder comprising:
a display support member configured to carry a sign without adherence of the sign to the display support member;
an attachment member which is connected to the display support member so that the attachment member can be oriented relative to the display support display member at a selected one of a range of maintainable pivot angles;
means for securing the attachment member to an external surface.

2. The apparatus of claim 1, wherein the display support display member comprises:
a panel section comprising a panel display surface;
a lower clip connected proximate a lower end of the panel section and which is configured at least partially to form a lower channel;
an upper clip connected proximate an upper end of the panel section and is configured at least partially to form an upper channel; and
wherein the lower clip and the upper clip at least partially form a track, the track being configured to receive or accommodate a sign which can be slidably inserted into or removed from the track.

3. The apparatus of claim 1, wherein:
the display support display member comprises a panel section comprising a panel display surface and a panel edge which is configured to form a pivot channel; and
the attachment member comprises an attachment member edge which is configured for pivotal insertion into the pivot channel.

4. The apparatus of claim 1, wherein the attachment member serves as an auxiliary or alternative display member configured to carry a second sign.

5. The apparatus of claim 1, wherein the attachment member comprises:
an auxiliary panel;
an auxiliary panel lower clip connected proximate a lower end of the auxiliary panel and which is configured at least partially to form an auxiliary panel lower channel;
an auxiliary panel upper clip connected proximate an upper end of the auxiliary panel and which is configured at least partially to form an auxiliary panel upper channel; and
wherein the auxiliary panel lower clip and the auxiliary panel upper clip at least partially form an auxiliary panel track, the auxiliary panel track being configured to receive or accommodate the second sign which can be slidably inserted into or removed from the auxiliary panel track.

6. The apparatus of claim 1, wherein the attachment member comprises an auxiliary panel configured to bear a second sign; and wherein the means for securing the attachment member to the external surface comprises a pair of spaced apart suction cups positioned to preclude lateral translation of the second sticker along the auxiliary panel.

7. A sign holder comprising:
a display support member comprising:
a panel section comprising a panel display surface;
a lower clip connected proximate a lower end of the panel section and which is configured at least partially to form a lower channel;
an upper clip connected proximate an upper end of the panel section and is configured at least partially to form an upper channel; and
wherein the lower clip and the upper clip at least partially form a track, the track being configured to receive or accommodate a sign which can be slidably inserted into or removed from the track;
an attachment member which is pivotally connected to the display support member;
means for securing the attachment member to an external surface.

8. The apparatus of claim 7, wherein:
the display support display member comprises a panel section comprising a panel display surface and a panel edge which is configured to form a pivot channel; and
the attachment member comprises an attachment member edge which is configured for pivotal insertion into the pivot channel.

9. The apparatus of claim 8, wherein the panel edge is curved to extend slightly rearward of plane of the panel display surface and then to arc forward in hook-like fashion to form the pivot channel.

10. The apparatus of claim 7, wherein the attachment member serves as an auxiliary or alternative display member configured to carry a second sign.

11. The apparatus of claim 7, wherein the attachment member comprises:
an auxiliary panel;
an auxiliary panel lower clip connected proximate a lower end of the auxiliary panel and which is configured at least partially to form an auxiliary panel lower channel;
an auxiliary panel upper clip connected proximate an upper end of the auxiliary panel and which is configured at least partially to form an auxiliary panel upper channel; and
wherein the auxiliary panel lower clip and the auxiliary panel upper clip at least partially form an auxiliary panel track, the auxiliary panel track being configured to receive or accommodate the second sign which can be slidably inserted into or removed from the auxiliary panel track.

12. The apparatus of claim 7, wherein the attachment member comprises an auxiliary panel configured to bear a second sign; and wherein the means for securing the attachment member to the external surface comprises a pair of spaced apart suction cups positioned to preclude lateral translation of the second sticker along the auxiliary panel.

13. A sign holder comprising:
a display support member configured to carry a sign;
an attachment member configured to carry a second sign and connected to the display support member;
means for securing the attachment member to an external surface.

14. The apparatus of claim 13, wherein the display support display member comprises:
a panel section comprising a panel display surface;
a lower clip connected proximate a lower end of the panel section and which is configured at least partially to form a lower channel;
an upper clip connected proximate an upper end of the panel section and is configured at least partially to form an upper channel; and
wherein the lower clip and the upper clip at least partially form a track, the track being configured to receive or accommodate a sign which can be slidably inserted into or removed from the track.

15. The apparatus of claim 13, wherein:
the display support display member comprises a panel section comprising a panel display surface and a panel edge which is configured to form a pivot channel; and
the attachment member comprises an attachment member edge which is configured for pivotal insertion into the pivot channel.

16. The apparatus of claim 13, wherein the attachment member comprises:
an auxiliary panel;
an auxiliary panel lower clip connected proximate a lower end of the auxiliary panel and which is configured at least partially to form an auxiliary panel lower channel;
an auxiliary panel upper clip connected proximate an upper end of the auxiliary panel and which is configured at least partially to form an auxiliary panel upper channel; and
wherein the auxiliary panel lower clip and the auxiliary panel upper clip at least partially form an auxiliary panel track, the auxiliary panel track being configured to receive or accommodate the second sign which can be slidably inserted into or removed from the auxiliary panel track.

17. The apparatus of claim 13, wherein the attachment member comprises an auxiliary panel configured to bear the second sign; and wherein the means for securing the attachment member to the external surface comprises a pair of spaced apart suction cups positioned to preclude lateral translation of the second sticker along the auxiliary panel.

18. The apparatus of claim 13, wherein the attachment member is connected to the display support member so that the attachment member can be oriented relative to the display support display member at a selected one of a range of maintainable pivot angles

19. A sign holder comprising:
a display support member comprising:
a panel section comprising a panel display surface;
a lower clip connected proximate a lower end of the panel section and which is configured at least partially to form a lower channel;
an upper clip connected proximate an upper end of the panel section and is configured at least partially to form an upper channel; and
wherein the lower clip and the upper clip at least partially form a track, the track being configured to receive or accommodate a sign which can be slidably inserted into or removed from the track;
an attachment member configured to carry a second sign and connected to the display support member, the attachment member comprising:
an auxiliary panel;
an auxiliary panel lower clip connected proximate a lower end of the auxiliary panel and which is configured at least partially to form an auxiliary panel lower channel;
an auxiliary panel upper clip connected proximate an upper end of the auxiliary panel and which is configured at least partially to form an auxiliary panel upper channel; and
wherein the auxiliary panel lower clip and the auxiliary panel upper clip at least partially form an auxiliary panel track, the auxiliary panel track being configured to receive or accommodate the second sign which can be slidably inserted into or removed from the auxiliary panel track.

20. The apparatus of claim 19, wherein the means for securing the attachment member to the external surface comprises a pair of spaced apart suction cups positioned to preclude lateral translation of the second sticker along the auxiliary panel.
